(19) United States
(12) Patent Application Publication
(10) Pub. No.: US 2010/0225069 A1
(43) Pub. Date: Sep. 9, 2010

(54) OIL RESISTANT RTV SILICONE

(75) Inventors: Hans E. Haas, Solon, OH (US); Andrea Rigby, Lyndhurst, OH (US); Jason Kopelwitz, New Philadelphia, OH (US)

Correspondence Address: GIFFORD, KRASS, SPRINKLE,ANDERSON & CITKOWSKI, P.C, PO BOX 7021, TROY, MI, 48007-7021, US

(73) Assignee: ILLINOIS TOOL WORKS, INC.

(21) Appl. No.: 12/718,531

(22) Filed: Mar. 5, 2010

Related U.S. Application Data
(60) Provisional application No. 61/157,763, filed on Mar. 5, 2009.

(51) Int. Cl. F16J 15/06; C08K 5/29; B05D 3/02; F02F 11/00

(52) U.S. Cl. 277/591; 524/195; 427/385.5; 277/650

(57) ABSTRACT

The compositions and methods of the invention are related to RTV silicones having enhanced oil resistance. The compositions of the invention are useful for forming seals having oil resistance and desired tensile strengths after exposure to oil, including gear oil. The compositions are also useful for manufacturing articles sealed with the cured oil resistant RTV silicones.

### CROSS-REFERENCE TO RELATED APPLICATION

This application claims priority of U.S. Provisional Patent Application Ser. No. 61/157,763 filed Mar. 5, 2009, which is incorporated herein by reference.

### FIELD OF THE INVENTION

The present invention in general relates to RTV silicone and, in particular, to an RTV silicone having gear oil resistant properties.

### BACKGROUND OF THE INVENTION

RTV silicone presently is the preeminent material in forming vehicle power train seals that include oil pan, valve cover, and transmission pan seals. Because of the exposure to oil at elevated temperatures, including such exposure to gear oil, efforts have been made to develop RTV silicone that has oil resistance properties. Indeed, it is recognized that certain grades of gear oils are known to quickly break down RTV silicone materials due to the additive package and base oils they contain; and substantial losses in tensile strength occur, often in newer gear oil formulations. Thus, there exists a need for RTV silicones with enhanced oil resistance properties, more particularly for such RTV silicones that maintain certain desired tensile strengths.

### SUMMARY OF THE INVENTION

The compositions and methods of the invention are related to RTV silicones having enhanced oil resistance. The compositions of the invention are useful for forming seals having oil resistance and desired tensile strengths after exposure to oil, including gear oil. The compositions are also useful for manufacturing articles sealed with the cured oil resistant RTV silicones.

A condensation curable silicone composition is provided that includes a hydroxy-terminated diorgano polysiloxane and a performance enhancing additive of dicyandiamide.

Alternatively, a condensation curable silicone composition is provided that includes a hydroxy-terminated diorgano polysiloxane; a filler component including a magnesium oxide, zinc oxide, or calcium oxide; and an additive component comprising a compound having at least two terminal functional groups wherein each said terminal functional group is independently selected from: epoxy functional group, unsaturated hydrocarbon functional group, and amine functional group. In one embodiment, the at least two terminal functional groups are each independently selected from —CH═CH₂ and

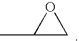

In another, the at least two unsaturated hydrocarbon functional groups have the structure: —CH═CH₂.

The cured form of the inventive composition demonstrates enhanced oil resistance. An additive component is provided that includes a cyandiamide derivative or at least one of:
a) compound of the general formula:
   I) R1-(R2-X)ₙ, or
   II) Z-M˜(R2-X)ₙ, wherein
      R1 and R2 are each independently any carbon containing structure, X is any —CH═CH₂, —CH≡CH or

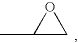

n is 2 or more,
˜ is 1 to 4 bonds,
Z is independently zero to 3 of hydrogen, —OH, or ═O,
M is an atom selected from a metal, boron, nitrogen, oxygen, phosphate, sulfur, or carbon; and
b) an amine containing at least two amine functional groups wherein each functional group is independently a primary or secondary amine functional group.

In a particular embodiment, X is acrylate, methacrylate, vinyl ether, or vinyl ester. An additive component is also provided that includes at least one of: a di-glycidyl ether, a trifunctional epoxy, a diacrylate, a di-vinyl ether, a trimethacrylate, a triacrylate, a phenolic resin having an aliphatic amine moiety.

An inventive composition also optionally includes a filler component of calcium carbonate, calcium oxide, diatomaceous earth, carbon black, magnesium oxide, magnesium hydroxide, zinc oxide, other metal oxide particulate, silica, or combinations thereof.

In instances when the filler component includes calcium carbonate, the calcium carbonate is preferably present at 10-40% by weight of said composition. Exemplary calcium carbonate for use herein is precipitated calcium carbonate of less than 500 nm particle size.

An inventive composition including magnesium oxide, zinc oxide, or calcium oxide as the filler component of the inventive composition preferably has a particle size of less than about 5 microns or more than about 1.5 microns or a mixture thereof. In another embodiment, the magnesium oxide, zinc oxide, or calcium oxide has a mean surface area of less than about 50 square meters per gram (m²/g) or more than about 175 m²/g or a mixture thereof.

An exemplary hydroxy-terminated diorgano polysiloxane of the inventive composition is hydroxy-terminated polydimethylsiloxane.

In a particular composition, the hydroxy-terminated diorgano polysiloxane is 20-60% by weight; the magnesium oxide, zinc oxide, or calcium oxide is 5-25% by weight; and the additive component is 2-20% by weight of the inventive composition.

Optionally, the inventive composition further includes a crosslinker. An exemplary crosslinker is an oximino silane. Typically, the crosslinker is 0-5% by weight of the inventive composition.

An inventive composition has an additive component that further optionally includes at least one of a pigment, plasticizer, fumed silica, or precipitated silica. Typically, each of the pigment, plasticizer, filmed silica, or precipitated silica is 0-5% by weight of the composition.

An inventive composition further optionally includes a condensation cure catalyst selected from the group consisting of dialkyldi(β-diketo) stannate, dialkyltin dicarboxylate, calcium dicarboxylate, zinc dicarboxylate, butyltitanium chelate compound, dibutyltin diacetate, dibutyltin dilaurate, and dibutyltin di(2-ethylhexanoate). Typically, the condensation cure catalyst is 0-5% by weight of the composition.

The invention also provides a process of providing an oil resistant composition to a surface exposed to oil that includes: applying an inventive composition as detailed above to a surface; forming the composition into an appropriate sealing configuration; and allowing the composition to cure. The cured composition is intended to demonstrate enhanced oil resistance. In a related aspect, the invention provides a silicone article formed from an inventive composition described herein. A gasket or O-ring is also formed from the inventive article.

### DETAILED DESCRIPTION OF THE INVENTION

The present invention has utility as a cured silicone producing composition with performance properties making the present invention particularly useful in combustion engine power train assemblies. The present invention provides a performance-enhancing additive of dicyandiamide in one embodiment that not only enhances performance of the cured silicone but also forms a stable dispersion in a curable base silicone fluid.

The invention broadly encompasses a condensation curable silicone composition which includes a base silicone fluid containing polysiloxane and a performance-enhancing additive of cyandiamide derivative, alone or in combination with, or wholly replaced by, a filler component of magnesium oxide, zinc oxide, or calcium oxide or a combination thereof; and an additive component including a compound having at least two terminal functional groups wherein each of the terminal functional groups is independently epoxy functional group, unsaturated hydrocarbon functional group, and amine functional group.

As used herein, “silicone fluid” includes room temperature condensation curing silicone polymers. These polymers cure/vulcanize with moisture from ambient air over a wide temperature range. Representative silicone fluid polymers conventional to the art typically contain functional groups capable of reacting with ambient moisture to substantially induce cure. Representative of such polymers are acetoxy silanes or diorganopolysiloxanes terminated with hydroxyl, the reaction product thereof with a silicone crosslinker, or a combination of these polymers. It is appreciated that other silicone fluids are operative herein provided that upon condensation cure, the resulting composition has the desired enhanced oil resistance property described herein.

“Enhanced oil resistance” as used herein means that the inventive condensation cured composition has a tensile strength of at least 80 psi, more preferably 120 psi, or most preferably 150 psi or more following submersion for 168 hours in gear oil of OEM specification MS-9763 (Chrysler) at 150° C., the tensile strength determined according to ASTM D412.

As used herein, a “cyanamide derivative” is defined as a molecule having a molecular weight of less than 500 Daltons that contains both a cyano (—CH) and amide C(NH)NH₂ moieties. Specific examples of cyanamide derivatives operative herein include chlorohexidine, biguanide, 3-amino-1,2,4-trazole, aminoguanidine, tetramethyl guanidine, benzoguanamine, 1-o-tolylbiguanide, 2-aminopyrimidine, dodecyl guanidine, guanidine, cyanamide, dicyandiamide, butylbiguanide, 2-amino-4-methoxy-6-methyl-1,3,5-trazine, phenylguanidine, O-methylisourea, amino guanidine bicarbonate, 3-amino-5-carboxy-1,2,4-triazole, 5-amino-1H-tetrazole, 3-amino-5-mercapto-1,2,4-triazole, and 2-amino-4,6-dimethoxy-pyrimidine.

For the purposes of the invention, the silicone fluid used herein typically has a viscosity in the range from about 500 to about 1200,000 Centistokes (Cst) when measured at 25° C. In general, lower viscosity fluids provide improved oil resistance, so fluids of less than 25,000 Cst are preferred and less than 10,000 Cst highly preferred. The silicone fluid used herein can be selected from the fluids, polysiloxanes, and diorganosiloxanes described in U.S. Pat. Nos. 4,514,529; 6,444,740; 6,103,804; and 7,205,050; the entire contents of each of which patents are hereby incorporated herein by reference. For the purposes of the invention, the silicone fluid is 20-60% by weight of the inventive composition.

A suitable polysiloxane operative herein is a hydroxy-terminated diorganopolysiloxane represented by the structure: HO—(—SiR³R⁴—O—)ₙ—H wherein R³ and R⁴ are independently an unsubstituted or substituted monovalent hydrocarbon group exemplified by alkyl groups, such as methyl, ethyl, propyl, and butyl groups; cycloalkyl groups, such as cyclopentyl or cyclohexyl groups; alkenyl groups, such as vinyl and allyl groups; and aryl groups, such as phenyl and tolyl groups; as well as those substituted groups obtained by replacing a part or all of the hydrogen atoms in the above-referenced hydrocarbon groups with halogen atoms (such as trihalopropyl), cyano groups, and the like; and n is at least 2. In a particular embodiment, the hydroxy-terminated diorganopolysiloxane is hydroxy-terminated polydimethylsiloxane (PDMS). In a more particular embodiment, the PDMS has a viscosity of 500-1200,000 Cst.

In a preferred embodiment the cyanamide derivative is dicyandiamide H₂NC(═NH)NHCN and is added to a curable polysiloxane formulation. Dicyandiamide is solid at 20° C. and preferably added as a powder mixed throughout the curable polysiloxane formulation. Typically, cyanamide derivative loadings range from 0.5 to 10 total weight percent of curable polysiloxane formulation absent fillers.

In another embodiment, the additive component includes an alkali earth oxide or hydroxide and at least one of a) or b):
a) compound of the general formula:
   I) R1-(R2-X)ₙ, or
   II) Z-M˜(R2-X)ₙ, wherein
      R1 and R2 are each independently any carbon containing structure,
      X is any —CH═CH₂, —C≡CH or

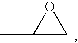

n is 2 or more,
˜ is 1 to 4 bonds,
Z is independently zero to 3 of hydrogen, —OH, or ═O,
M is an atom selected from a metal, boron, nitrogen, oxygen, phosphate, sulfur, or carbon; or
b) an amine containing at least two amine functional groups wherein each functional group is independently a primary or secondary amine functional group.

For the purposes of the invention, a “carbon containing structure” is any saturated or unsaturated, branched or straight, cyclic or acyclic hydrocarbon group including and exemplified by alkyl groups such as methyl, ethyl, propyl, and butyl groups; alkenyl groups such as vinyl and allyl groups; alkynyl groups; cycloalkyl groups such as cyclopentyl or cyclohexyl groups; and aryl groups such as phenyl and tolyl groups; as well as those substituted groups obtained by replacing a part or all of the hydrogen atoms in the above-referenced hydrocarbon groups with halogen including bromo, chloro, and fluoro (such as trihalopropyl), —OH, ═O, amino, cyano groups, and the like; including structures containing all aliphatic (carbon to carbon) linkages and structures containing one or more non-aliphatic linkages exemplified by and including ester and ether linkages and the like. Any chain length or substitution is encompassed by the carbon containing structure, so long as the use of the structure for the purposes of the invention as described herein maintains the enhanced oil resistance of cured inventive composition. In one embodiment, the carbon containing structure is C₂ to C₆ alkyl or alkenyl. In another, the carbon containing structure is C₂ to C₁₂ alkyl or alkenyl. In another, the carbon containing structure is C₂ to C₂₄ alkyl or alkenyl. In one embodiment, the specified carbon number ranges include all integers and endpoints within the specified ranges as well as including those ranges definable by overlapping the specified ranges (e.g. C₆ to C₁₂). In a particular embodiment, the carbon containing structure comprises at least one ester or ether linkage.

In a particular embodiment, X is acrylate, methacrylate, vinyl ether, or vinyl ester.

In another embodiment, the additive component includes at least one of: a di-glycidyl ether, a trifunctional epoxy, a diacrylate, a di-vinyl ether, a trimethacrylate, a triacrylate, a phenolic resin having an aliphatic amine moiety, EPON 58034, GE 100, SARET 633, VECTOMER 4060, SARTOMER SR350, SARTOMER SR 351, or ANCAMINE.

The composition further comprises a filler component selected from the group consisting of calcium carbonate, calcium oxide, diatomaceous earth, carbon black, magnesium oxide, magnesium hydroxide, zinc oxide, other metal oxide particulate, silica, and combinations thereof.

In a particular embodiment, the filler component further includes calcium carbonate. In a more particular embodiment, the filler component comprises magnesium oxide, zinc oxide, calcium, oxide, calcium carbonate, or combinations thereof. Calcium carbonate is typically present from 10-40% by weight of the composition. In another, the calcium carbonate is precipitated calcium carbonate of less than 500 nm maximum linear dimension particle size.

It is recognized that the particular particle size, surface area, or grade of a metal oxide including magnesium oxide, calcium oxide, zinc oxide, and other metal oxide is not restrictive. Thus, any particle size, surface area, or grade of a metal oxide is operable for the purposes of the invention.

In a particular embodiment of the present invention, the magnesium oxide of the filler component of the inventive composition has a particle size of less than about 5 microns or more than about 1.5 microns or a mixture thereof. In another embodiment, the magnesium oxide has a mean surface area of less than about 50 m²/g or more than about 175 m²/g or a mixture thereof.

In another embodiment, the hydroxy-terminated diorgano polysiloxane is 20-60% by weight; the magnesium oxide, calcium oxide, zinc oxide, or combination thereof is 5-25% by weight; and the additive component is 2-20% by weight of the inventive composition.

One or more crosslinkers are added to the inventive composition to allow condensation cure of the composition. Thus, an inventive composition described herein also includes a crosslinker. Any conventional crosslinker known to the art that is capable of reaction with a silicone fluid according to the present invention at room temperature under condensation cure conditions is operative herein, with the proviso that the crosslinker is not an acetoxy crosslinker. A crosslinker operative in the present invention illustratively includes methyltrimethoxysilane, vinyltrimethoxysilane, methyltriethoxysilane, vinyltriethoxysilane, methyltriacetoxysilane, methyl tris-(N-methylbenzamido)silane, methyl tris-(isopropenoxy)silane, methyl tris(cyclohexylamino)silane, methyl tris-(methyl ethyl ketoximino)silane, vinyl tris-(methyl ethyl ketoximino)silane, methyl tris-(methyl isobutyl ketoximino)silane, vinyl tris-(methyl isobutyl ketoximino)silane, tetrakis-(methyl ethyl ketoximino)silane, tetrakis-(methyl isobutyl ketoximino)silane, tetrakis-(methyl amyl ketoximino)silane, dimethyl bis-(methyl ethyl ketoximino)silane, methyl vinyl bis-(methyl ethyl ketoximino)silane, methyl vinyl bis-(methyl isobutyl ketoximino)silane, methyl vinyl bis-(methyl amyl ketoximino)silane, tetrafunctional alkoxy-ketoxime silanes, tetrafunctional alkoxy-ketoximino silanes and enoxysilanes. In one embodiment, the crosslinker is an oximino silane. In another embodiment, the crosslinker is an oximino silane crosslinker selected from the crosslinkers specifically listed above. In another embodiment, the crosslinker is vinyl tris(methyl ethyl ketoximino)silane (VOS) or tetra(methylethylketoximino)silane (TOS) or mixtures thereof. In another embodiment, the crosslinker is 0-5% by weight of the composition.

In other particular embodiments, the additive component further optionally comprises at least one of a pigment, plasticizer, fumed silica, or precipitated silica. The pigment, plasticizer, and silica are readily and commercially available. For example, particular embodiments include aluminum flake, titanium dioxide pigment, and/or fumed silica. In one embodiment, the pigment, plasticizer, fumed silica, or precipitated silica is each independently present 0-5% by weight of said composition.

The silicone compositions of the present invention may also include a plasticizer, such as aliphatic liquid polymers and oils, illustratively including alkyl phosphates, polyalkylene glycol, poly(propylene oxides), hydroxyethylated alkyl phenol, dialkyldithiophosphonate, poly(isobutylenes), poly(α-olefins), and mixtures thereof.

The present invention also optionally includes effective amounts of a condensation cure catalyst conventional to the art to facilitate silicone fluid adherence to an RTV silicone. In one embodiment, the condensation cure catalyst is 0-1% or 0.05-0.5% by weight of said composition.

Condensation cure catalysts conventional to the art and operative herein representatively include organometallics of the metals including tin, zirconium, lead, iron, cobalt, manganese, antimony, bismuth, and zinc. Representative of these organometallic condensation catalysts are dibutyl tin dilaurate, dibutyl tin diacetate, dibutyl tin dimethoxide, tin oleate, dibutyl tin maleate, and combinations thereof; titanium compounds such as 1,3-propanedioxytitanium bis(ethylacetoacetate), 1,3-propanedioxytitanium bis(acetylacetonate), diisopropoxytitanium bis(acetylacetonate), titanium naphthenate, tetrabutyltitanate, tetra-2-ethylhexyltitanate, tetraphenyltitanate, tetraoctadecyltitanate, ethyltriethanolaminetitanate, and β-dicarbonyltitanium compounds; organozirconium compounds such as zirconium octoanate; and esters of the above-recited organometallics, the esters illustratively including 2-alkyl octoanate, alkyl hexoanate; carboxylates illustratively including octoanate, stearate, and naphthenate. Non-metallic condensation catalysts conventional to the art and operative herein include primary, secondary, or tertiary amines, illustratively including hexylammonium acetate, aminopropyltrialkoxysilane, and benzyltrimethyl ammonium acetate. In another particular embodiment, the inventive composition optionally comprises a condensation cure catalyst selected from the group consisting of dialkyldi(β-diketo) stannate, dialkyltin dicarboxylate, calcium dicarboxylate, zinc dicarboxylate, butyltitanium chelate compound, dibutyltin diacetate, dibutyltin dilaurate, and dibutyltin di(2-ethylhexanoate). In one embodiment, the condensation cure catalyst is 0-5% by weight of said composition.

It is appreciated that the silicone fluid, filler, additive, crosslinker, pigment, plasticizer, silica, and condensation cure catalysts specifically described herein are operative, provided that upon condensation cure the resulting composition has the desired enhanced oil resistance described herein.

In another aspect, the invention provides a method of providing an oil resistant composition to a surface exposed to oil, the method comprising: applying a composition according to claim 1 to a surface; forming the composition into an appropriate sealing configuration; and allowing the composition to cure.

In one embodiment, the cured composition demonstrates enhanced oil resistance. In a related aspect, the invention provides a silicone article formed from an inventive composition described herein.

In a further related embodiment, the invention provides a gasket or O-ring formed from the inventive article.

The present invention is further detailed with respect to the following non-limiting examples.

### EXAMPLES

### Example 1

### Cyanamide Derivative Inventive Composition, Typical Manufacturing Process and Test Methods

| Ingredient | % weight |
|---|---|
| hydroxy terminated polydimethylsiloxane (PDMS) | 20-60 |
| (viscosity 500-1200,000 Csy) | |
| cyanamide derivative (e.g. dicyanamide) | 1-10 |
| precipitated calcium carbonate (PCC)- small particle | 10-40 |
| size preferred (<500 nm) | |
| Pigment (optional) (e.g. aluminum, TiO₂, carbon black) | 0-5 |
| surface treated fumed or precipitated silica (optional) | 0-5 |
| TOS/VOS (crosslinker) | 0-5 |
| VOS (crosslinker) | 1.0-5 |
| Plasticizer (optional) (may be unreactive PDMS or | 0-15 |
| organic fluid) | |

### Example 2

### Compositions, Typical Manufacturing Process and Test Methods

| Ingredient | % weight |
|---|---|
| hydroxy terminated polydimethylsiloxane (PDMS) | 20-60 |
| (viscosity 500-1200,000 Csy) | |
| Alkali earth oxide of any particle size or surface area | 5-25 |
| precipitated calcium carbonate (PCC)-small particle size preferred (<500 nm) | 10-40 |
| Pigment (optional) (e.g. aluminum, TiO₂, carbon black) | 0-5 |
| surface treated fumed or precipitated silica (optional) | 0-5 |
| TOS/VOS (crosslinker) | 0-5 |
| VOS (crosslinker) | 1.0-5 |
| Plasticizer (optional) (may be unreactive PDMS or organic fluid) | 0-15 |
| Minimally difunctional additive (at least 2 terminal epoxy, amine or | 1-20 |
| unsaturated groups): additional data is included to validate the 1% level | |

Epoxy fuctional examples:
Epon 58034 (an elastomer modified epoxy functional adduct formed from the reaction of
HELOXY ™ 68 modifier and a carboxyl terminated butadiene-acrylonitrile elastomer)
GE100 (tri-functional epoxy)
Unsaturated examples:
Saret SR 633 (diacrylate)*
Vectomer 4060 (di-vinyl ether)
Sartomer SR350 (tri-methacrylate)
Sartomer SR351 (tri-acrylate)
Amine example:
Ancamine 2014 AS (aliphatic amines with phenolic resin of unknown structure)
*Saret SR 633:

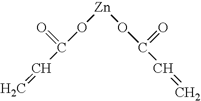

### General Process for Manufacturing Follows:

Charging hydroxy PDMS, PCC, alkali earth oxide or cyanamide derivative, fumed silica;
Mixing with heating and vacuum if moisture removal required—30-120 minutes;
Cooling, then adding crosslinkers;
If alkali earth oxide present then adding the additive (minimally difunctional (at least 2 terminal epoxy, amine or unsaturated groups) additive);
Adding remaining optional additives;
Mix until uniform—10-60 minutes;
Mix until uniform—10-60 minutes. Variations are recognizable by the ordinarily skilled artisan, and include condensation cure processes, and other processes compatible with condensation cure processes, such as those described in U.S. Pat. Nos. 4,514,529; 6,444,740; 6,103,804; and 7,205,050; the entire contents of each of which patents are hereby incorporated herein by reference.

### Test Methods:

Tensile strength and elongation ASTM D412

Fluid immersion testing ASTM D471 (time and temperature as specified)

Shore A Hardness: ASTM D2240.

### Example 3

### Test Data

P number designations in the tables below denote experimental samples.

TABLE I

| | | Comparative | | | | |
|---|---|---|---|---|---|---|
| | Control | Mopar Sample | Inventive A | Inventive B | Inventive C | Inventive D |
| Description of | Control Permatex ® | Mopar ® MS-GF 46 | +5 total wt % | +2 total wt % | +5 total wt % | +5 total wt % |
| RTV silicone | Ultra Grey RTV | silicone (Iron | dicyanadiamide | dicyandiamide | dicyandiamide | guanidine |
| Composition | silicone (24 total | oxide, magnesium | yields 24 total | yields 23.5 total | yields 22.8 total | yields 27.8 total |
| | wt % calcium | oxide, and calcium | wt % calcium | wt % calcium | wt % calcium | wt % calcium |
| | carbonate) | carbonate) | carbonate | carbonate | carbonate | carbonate |
| Initial Tensile | 394 psi | 213 psi | | | 375 psi | |
| Strength | | | | | | |
| Tensile | 32 psi | 84 psi | | | 251 psi | |
| Strength after | | | | | | |
| 1 week in Gear | | | | | | |
| Oil @ 150° C. | | | | | | |
| % Change | −92% | −61% | | | −33% | |

| | Inventive E | Inventive F | Inventive G | Inventive H |
|---|---|---|---|---|
| Description of | +19 total wt % | +10 total wt % | +10 total wt % | +10 total wt % |
| RTV silicone | Magnesium oxide and | Epoxy resin, +18 | Unsaturated | Unsaturated |
| Composition | yields 16 total | total wt % | acrylate, +19 | vinyl ether, +19 |
| | wt % calcium | magnesium oxide, and | total wt % | total wt % |
| | carbonate | yields 16 total | magnesium oxide, and | magnesium oxide, and |
| | | wt % calcium | yields 16 total | yields 16 total |
| | | carbonate | wt % calcium | wt % calcium |
| | | | carbonate | carbonate |
| Initial Tensile | 265 psi | 202 psi | 351 psi | 223 psi |
| Strength | | | | |
| Tensile | no data- | 137 psi | 266 psi | 228 psi |
| Strength after | samples | | | |
| 1 week in Gear | fell apart | | | |
| Oil @ 150° C. | | | | |
| % Change | −100% | −32% | −24% | +2% |

TABLE II
Preliminary Test Data

| Description | I | Inventive F | J | K | Inventive E |
|---|---|---|---|---|---|
| 20,000 Cst OH fluid | 44.30 | 51.00 | 44.30 | 51.00 | 50.50 |
| Al Flake | 0.67 | 0.67 | 0.67 | 0.67 | 0.67 |
| MgO | 14.30 | 18.10 | 14.30 | 18.10 | 18.30 |
| PPC | 12.40 | 16.20 | 12.40 | 16.20 | 16.35 |
| Red Iron Oxide | 14.30 | | 14.30 | | |
| Dicyandiamide | — | — | — | — | — |
| Epon Resin | 9.50 | 9.50 | | | 4.80 |
| SR 351 | | | 9.50 | 9.50 | 4.80 |
| VOS | 3.80 | 3.80 | 3.80 | 3.80 | 3.85 |
| Ureidosilane | 0.67 | 0.67 | 0.67 | 0.67 | 0.67 |
| Dimethyl tin mercaptide | 0.10 | 0.10 | 0.10 | 0.10 | 0.10 |

| Test | Spec | P32-14 | P32-10 | P32-15 | P32-11-2 | P32-12 |
|---|---|---|---|---|---|---|
| Initial | | | | | | |
| Durometer | 48 + 5 points | 43 points | 40 points | 45 points | 40 points | 37 points |
| Tensile Strength | 247 psi minimum | 238 psi | 202 psi | 289 psi | 206 psi | 192 psi |
| Elongation | 200% minimum | 431% | 399% | 346% | 417% | 413% |
| Fluid Aging - | | | | | | |
| Gear Oil 150° C. | | | | | | |
| Durometer | 10 points, minimum | 60 points | 55 points | 31 points | 30 points | 50 points |
| Tensile Strength | 196 psi minimum | 123 psi | 137 psi | 97 psi | 88 psi | 138 psi |
| Elongation | 150% minimum | 35% | 28% | 82% | 123% | 51% |

TABLE III

| | Inventive L | E | M | C |
|---|---|---|---|---|
| Description | WT % | WT % | WT % | WT % |
| 6,000 Cst OH fluid | 45.50 | 54.30 | 44.3 | 40.38 |
| Al Flake | 0.70 | 0.70 | 0.7 | 0.67 |
| TOS/VOS | | 4.00 | 1 | 1.27 |
| VOS | 4.00 | 1.00 | 4 | 5.38 |
| Fumed silica | 3.00 | 5.00 | 3 | 2.85 |
| PPC | 46.00 | 16.00 | 30 | 22.80 |
| MgO | | 19.00 | 15 | — |
| Ureidosilane | 0.70 | 0.00 | 0 | |
| Dimethyl tin mercaptide | 0.10 | 0.00 | 0 | |
| Dicyandiamide | | | | 5 |
| | 100.00 | 100.00 | 98.00 | 100 |

| Test | Spec | Inventive L | E | M | C |
|---|---|---|---|---|---|
| Initial | | | | | |
| Durometer | 48 + 5 points | 58 points | 43 points | 57 pt | |
| Tensile Strength | 247 psi minimum | 383 ± 27 psi | 265 ± 12 psi | 326 psi | 375 psi |
| Elongation | 200% minimum | 167 ± 16% | 454 ± 31% | 353% | 144 |
| Fluid Aging- | | | | | |
| Gear Oil 150° C. | | | | | |
| Durometer | 10 points, minimum | 23 points | samples | 10 pt | |
| Tensile Strength | 196 psi minimum | 71 ± 2 psi | fell apart - | 14 psi | 251 |
| Elongation | 150% minimum | 127 ± 5% | no data | 57% | 137 |

TABLE IV

| | | | P36-9-1 | P36-9-2 |
|---|---|---|---|---|
| | | P31-100-3 | SR351 | SR351 |
| | | 5% Saret | m'caps | m'caps |
| | Description | | | |
| | 6000 OH Fluid | 43.4 | 41.3 | 41.3 |
| | 80000 OH Fluid | 0.0 | 0.0 | 0.0 |
| | PPC | 29.5 | 28.0 | 28.0 |
| | MgO | 15.8 | 15.0 | 15.0 |
| | Al flake | 0.7 | 0.7 | 0.7 |
| | TOS/VOS | 2.1 | 2.0 | 2.0 |
| | VOS | 3.2 | 3.0 | 3.0 |
| Zinc diacrylate | SARET 633 | 5.3 | 0.0 | 0.0 |
| (non-melting powder) | | | | |
| Amine functional resin | ANCAMINE | 0.0 | 0.0 | 0.0 |
| (100 C. melt point) | | | | |
| micro-encapsulated SR351(90% | SR351 Microcaps 66-25 | 0.0 | 10.0 | 0.0 |
| active, 100 C. shell melt point) | | | | |
| | SR351 Microcaps 66-26 | 0.0 | 0.0 | 10.0 |
| | 100 cst | 0.0 | 0.0 | 0.0 |
| | | 100.0 | 100.0 | 100.0 |
| Test | Spec | | | |
| Initial | | | | |
| Durometer | 48 + 5 points | 70 | NA | NA |
| Tensile Strength | 247 psi minimum | 290 | 273 | 213 |
| Elongation | 200% minimum | 126% | 144% | 136% |
| 75w90 Fluid Aging- | | | | |
| Gear Oil 150° C. | | | | |
| Durometer | 10 points, minimum | 15 | 20 | 21 |
| Tensile Strength | 196 psi minimum | 139 | 161 | 106 |
| Elongation | 150% minimum | 326% | 161% | 125% |

TABLE V

| | | | P36-11-1 | P36-11-3 |
|---|---|---|---|---|
| | | P36-10-1 | 5% | 5% Saret, |
| | | 10% Saret | ANCAMINE | 5% 100 cst |
| | Description | | | |
| | 6000 OH Fluid | 41.3 | 43.4 | 38.9 |
| | 80000 OH Fluid | 0 | 0 | 0 |
| | PPC | 28 | 29.4 | 26.4 |
| | MgO | 15 | 15.8 | 14.1 |
| | Al flake | 0.68 | 0.68 | 6.4 |
| | TOS/VOS | 2 | 2.1 | 1 |
| | VOS | 3 | 3.2 | 4 |
| Zinc diacrylate | SARET 633 | 10 | 0 | 5 |
| (non-melting powder) | | | | |
| Amine functional resin | ANCAMINE | 0 | 5.3 | |
| (100 C. melt point) | | | | |
| micro-encapsulated SR351(90% | SR351 Microcaps 66-25 | 0 | 0 | 0 |
| active, 100 C. shell melt point) | | | | |
| | SR351 Microcaps 66-26 | 0 | 0 | 0 |
| | 100 cst | 0 | 0 | 5 |
| | | 100.0 | 99.9 | 100.8 |
| Test | Spec | | | |
| Initial | | | | |
| Durometer | 48 + 5 points | NA | NA | NA |
| Tensile Strength | 247 psi minimum | 209 | 272 | 229 |
| Elongation | 200% minimum | 126% | 198% | 345% |
| 75w90 Fluid Aging- | | | | |
| Gear Oil 150° C. | | | | |
| Durometer | 10 points, minimum | NA | 30 | 30 |
| Tensile Strength | 196 psi minimum | 194 | 194 | 234 |
| Elongation | 150% minimum | 370% | 174% | 437% |

TABLE VI

| | | P34-6-1 | P34-6-2 |
|---|---|---|---|
| | | 7% Saret | 7% Saret |
| | Description | | |
| | 6000 OH Fluid | 37.1 | 33.8 |
| | 80000 OH Fluid | 13 | 19.7 |
| | PPC | 25.1 | 22.9 |
| | MgO | 13.4 | 12.2 |
| | Al flake | 0.6 | 0.6 |
| | TOS/VOS | 1.3 | 1.3 |
| | VOS | 2.6 | 2.6 |
| Zinc diacrylate | SARET 633 | 6.9 | 6.9 |
| (non-melting powder) | | | |
| Amine functional resin | ANCAMINE | | |
| (100 C. melt point) | | | |
| micro-encapsulated SR351(90% | SR351 Microcaps 66-25 | 0 | 0 |
| active, 100 C. shell melt point) | | | |
| | SR351 Microcaps 66-26 | 0 | 0 |
| | 100 cst | 0 | 0 |
| | | 100.0 | 100.0 |
| Test | Spec | | |
| Initial | | | |
| Durometer | 48 + 5 points | 53 | 48 |
| Tensile Strength | 247 psi minimum | 264 | 264 |
| Elongation | 200% minimum | 320% | 409% |
| 75w90 Fluid Aging- | | | |
| Gear Oil 150° C. | | | |
| Durometer | 10 points, minimum | 15 | 11 |
| Tensile Strength | 196 psi minimum | 164 | 144 |
| Elongation | 150% minimum | 718% | 768% |

TABLE VII

| Experimental | | | | | | | | | | | |
|---|---|---|---|---|---|---|---|---|---|---|---|
| Sample: | | | | | | | | | | | |
| ANCAMINE | MagChem Ancamine 100 cst | | | | | | | | | | |
| ECHIP #1 | 6000 OH | 13000 OH | 20000 OH | Socal 322 | 35 | 2014AS | Plasticizer | OS/VOS | VOS | | Initial Cure |
| 5b | 53 | 0 | 0 | 20 | 10 | 7 | 5 | 2 | 3 | 100 | 50 c. 24 hr |
| 5a | 53 | 0 | 0 | 20 | 10 | 7 | 5 | 2 | 3 | 100 | 50 c. 24 hr |
| 2b | 51 | 0 | 0 | 20 | 15 | 4 | 5 | 2 | 3 | 100 | 50 c. 24 hr |
| 2a | 51 | 0 | 0 | 20 | 15 | 4 | 5 | 2 | 3 | 100 | 50 c. 24 hr |
| 1b | 40.5 | 0 | 0 | 27.5 | 15 | 7 | 5 | 2 | 3 | 100 | 50 c. 24 hr |
| 1a | 40.5 | 0 | 0 | 27.5 | 15 | 7 | 5 | 2 | 3 | 100 | 50 c. 24 hr |
| 18b | 0 | 0 | 36 | 35 | 15 | 4 | 5 | 2 | 3 | 100 | 72 hr RT; 5 hr 50 c. |
| 18a | 0 | 0 | 36 | 35 | 15 | 4 | 5 | 2 | 3 | 100 | 72 hr RT; 5 hr 50 c. |
| 15b | 0 | 0 | 40.5 | 27.5 | 15 | 7 | 5 | 2 | 3 | 100 | 72 hr RT; 5 hr 50 c. |
| 15a | 0 | 0 | 40.5 | 27.5 | 15 | 7 | 5 | 2 | 3 | 100 | 72 hr RT; 5 hr 50 c. |
| 22 | 36.5 | 0 | 0 | 36.5 | 15 | 7 | 0 | 2 | 3 | 100 | 50 c. 24 hr |
| 21 | 37.75 | 0 | 0 | 37.75 | 12.5 | 7 | 0 | 2 | 3 | 100 | 50 c. 24 hr |
| 20 | 38 | 0 | 0 | 38 | 15 | 4 | 0 | 2 | 3 | 100 | 50 c. 24 hr |
| 19 | 36 | 0 | 0 | 35 | 15 | 4 | 5 | 2 | 3 | 100 | 50 c. 24 hr |
| 17 | 0 | 0 | 52 | 20 | 12.5 | 5.5 | 5 | 2 | 3 | 100 | 72 hr RT; 5 hr 50 c. |
| 16 | 0 | 0 | 51 | 20 | 15 | 4 | 5 | 2 | 3 | 100 | 72 hr RT; 5 hr 50 c. |
| 14 | 0 | 0 | 56 | 20 | 10 | 4 | 5 | 2 | 3 | 100 | 72 hr RT; 5 hr 50 c. |
| 13 | 0 | 0 | 41 | 35 | 10 | 4 | 5 | 2 | 3 | 100 | 72 hr RT; 5 hr 50 c. |
| 12 | 0 | 0 | 45.5 | 27.5 | 10 | 7 | 5 | 2 | 3 | 100 | 72 hr RT; 5 hr 50 c. |
| 11 | 0 | 0 | 38 | 35 | 10 | 7 | 5 | 2 | 3 | 100 | 72 hr RT; 5 hr 50 c. |
| 10 | 0 | 0 | 40.5 | 27.5 | 15 | 7 | 5 | 2 | 3 | 100 | 72 hr RT; 5 hr 50 c. |
| 9 | 0 | 46 | 0 | 27.5 | 12.5 | 4 | 5 | 2 | 3 | 100 | 72 hr RT; 5 hr 50 c. |
| 8 | 0 | 48 | 0 | 20 | 15 | 7 | 5 | 2 | 3 | 100 | 72 hr RT; 5 hr 50 c. |
| 7 | 56 | 0 | 0 | 20 | 10 | 4 | 5 | 2 | 3 | 100 | 50 c. 24 hr |
| 6 | 36 | 0 | 0 | 35 | 15 | 4 | 5 | 2 | 3 | 100 | 50 c. 24 hr |
| 4 | 48.5 | 0 | 0 | 27.5 | 10 | 4 | 5 | 2 | 3 | 100 | 50 c. 24 hr |
| 3 | 33 | 0 | 0 | 35 | 15 | 7 | 5 | 2 | 3 | 100 | 50 c. 24 hr |

| Experimental | | | 150 c. 75w90 Gear Oil (1 wk) | | | | | | | Extrusion Rate | | | |
|---|---|---|---|---|---|---|---|---|---|---|---|---|---|
| Sample: | | | | | Δ | | | | | Initial | Initial | Initial | |
| ANCAMINE | Shore | TS | Elong | Shore | Shore | TS | | Elong | | (1 day | (6 day | (12 day | % |
| ECHIP #1 | A | (psi) | (%) | A | A | (psi) | % ΔTS | (%) | % ΔElong | RT) | RT) | RT) | decline |
| 5b | 33 | 165 | 304 | 2 | −31 | 71 | −57% | 347 | 14% | 900 | 360 | | −100% |
| 5a | 31 | 125 | 317 | 11 | −20 | 99 | −21% | 244 | −23% | 696 | 750 | | −100% |
| 2b | 34 | 187 | 338 | 12 | −22 | 115 | −39% | 234 | −31% | 840 | 850 | | −100% |
| 2a | 34 | 191 | 341 | 10 | −24 | 126 | −34% | 262 | −23% | 918 | 750 | | −100% |
| 1b | 44 | 224 | 303 | 20 | −24 | 173 | −23% | 306 | 1% | 549 | 430 | | −100% |
| 1a | 43 | 237 | 347 | 18 | −25 | | | | | 480 | 360 | | −100% |
| 18b | 44 | 270 | 633 | 4 | −40 | 105 | −61% | 568 | −10% | 142 | 112.8 | | −100% |
| 18a | 45 | 270 | 745 | 1 | −44 | 84 | −69% | 497 | −33% | 154 | 111 | | −100% |
| 15b | 45 | 246 | 565 | 9 | −36 | 100 | −59% | 375 | −34% | 118 | 88.2 | | −100% |
| 15a | 46 | 225 | 502 | 4 | −42 | 86 | −62% | 375 | −25% | 103 | 81.6 | | −100% |
| 22 | 63 | 280 | 301 | 34 | −29 | 230 | −18% | 317 | 5% | | 108 | | |
| 21 | 60 | 283 | 322 | 35 | −25 | 223 | −21% | 313 | −3% | | 72 | | |
| 20 | 60 | 284 | 307 | 26 | −34 | 224 | −21% | 366 | 19% | 194 | 108 | | −100% |
| 19 | 49 | 284 | 420 | 23 | −26 | 202 | −29% | 339 | −19% | 356 | 240 | | −100% |
| 17 | 32 | 190 | 594 | 0 | −32 | 62 | −67% | 385 | −35% | 291 | 267.6 | | −100% |
| 16 | 35 | 255 | 736 | 5 | −30 | 97 | −62% | 418 | −43% | 209 | 189.6 | | −100% |
| 14 | 29 | 150 | 376 | 2 | −27 | 56 | −63% | 322 | −14% | 369 | 360 | | −100% |
| 13 | 39 | 238 | 640 | 0 | −39 | 106 | −55% | 477 | −25% | 206 | 171 | | −100% |
| 12 | 36 | 228 | 651 | 3 | −33 | 103 | −55% | 489 | −25% | 248 | 231.6 | | −100% |
| 11 | 43 | 260 | 655 | 6 | −37 | 133 | −49% | 540 | −18% | 160 | 126.6 | | −100% |
| 10 | 35 | 193 | 502 | 0 | −35 | 73 | −62% | 602 | 20% | 252 | 272.4 | | −100% |
| 9 | 34 | 243 | 511 | 0 | −34 | 78 | −68% | 529 | 4% | 383 | 326.4 | | −100% |
| 8 | 35 | 197 | 352 | 5 | −30 | 101 | −49% | 444 | 26% | 420 | 372 | | −100% |
| 7 | 32 | 185 | 344 | 5 | −27 | 57 | −69% | 253 | −26% | 1020 | 780 | | −100% |
| 6 | 48 | 275 | 375 | 8 | −40 | 144 | −48% | 428 | 14% | 360 | 240 | | −100% |
| 4 | 33 | 206 | 419 | 15 | −18 | 141 | −32% | 267 | −36% | 780 | 620 | | −100% |
| 3 | 45 | 248 | 347 | 22 | −23 | 167 | −33% | 234 | −33% | 303 | 186 | | −100% |

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A condensation curable silicone composition comprising:
a hydroxy-terminated diorgano polysiloxane;
a cyanamide derivative;
a filler; and
a crosslinker for said hydroxy-terminated diorgano polysiloxane.

2. The composition of claim 1 wherein said cyanamide derivative is present from 1 to 10 total weight percent.

3. The composition of claim 1 wherein said cyanamide derivative is dicyandiamide.

4. The composition of claim 3 wherein dicyandiamide is present from 2 to 6 total weight percent.

5. The composition of claim 1 further comprising at least one of a pigment, plasticizer, fumed silica, or precipitated silica.

6. The composition of claim 1 wherein said filler is calcium carbonate.

7. The composition of claim 1 further comprising a filler component selected from the group consisting of diatomaceous earth, carbon black, magnesium hydroxide, other metal oxide particulate, and silica.

8. The composition of claim 6, wherein the calcium carbonate is 10-40% by weight of said composition.

9. The composition of claim 6, wherein the calcium carbonate is precipitated calcium carbonate of less than 500 nm particle size.

10. The composition of claim 1 wherein said hydroxy-terminated diorgano polysiloxane is hydroxy-terminated polydimethylsiloxane.

11. The composition of claim 1 wherein said crosslinker is an oximino silane.

12. The composition of claim 15, wherein said crosslinker is 0.5-7.0% by weight of said composition.

13. The composition of claim 1 further comprising a condensation cure catalyst selected from the group consisting of dialkyldi(β-diketo) stannate, dialkyltin dicarboxylate, calcium dicarboxylate, zinc dicarboxylate, butyltitanium chelate compound, dibutyltin diacetate, dibutyltin dilaurate, and dibutyltin di(2-ethylhexanoate).

14. A silicone article comprising a cured composition according to claim 1.

15. The article of claim 14 wherein the cured article is a gasket or an O-ring.

16. The article of claim 15 wherein the cured article forms a seal intermediate between a component of a vehicle power train.

17. The article of claim 16 wherein the component of the vehicle power train is an oil pan, a valve cover, or a transmission pan.

18. A method of providing an oil resistant composition to a surface exposed to oil, said method comprising:
applying to a surface a composition comprising a hydroxy-terminated diorgano polysiloxane, a cyanamide derivative, a filler, and a crosslinker for said hydroxy-terminated diorgano polysiloxane;
forming the composition into an appropriate sealing configuration; and
allowing the composition to cure.

19. The method of claim 18, wherein the cured composition demonstrates enhanced oil resistance.
